(19) United States
(12) Patent Application Publication
(10) Pub. No.: US 2013/0149166 A1
(43) Pub. Date: Jun. 13, 2013

(54) FORMATION OF A CORE STRUCTURE OF A WIND TURBINE ROTOR BLADE BY USING A PLURALITY OF BASIC CORE COMPONENTS

(71) Applicant: Karsten Schibsbye, Fredericia (DK)

(72) Inventor: Karsten Schibsbye, Fredericia (DK)

(21) Appl. No.: 13/817,030

(22) PCT Filed: Dec. 2, 2010
(86) PCT No.: PCT/EP2010/068745

§ 371 Date: Feb. 14, 2013

(30) Foreign Application Priority Data
Aug. 24, 2010 (EP) 10173803.7

(51) Int. Cl. F03D 1/06

(52) U.S. Cl. CPC F03D 1/0675
USPC 416/241 A; 427/299; 427/289

(57) ABSTRACT

A basic core component is provided for forming, together with at least one another basic core component, a core structure of a rotor blade of a wind turbine. The basic core component includes a precasted base element being made from a foam material, and a resin receiving layer, which is adhered to at least one surface of the precasted base element. When, during a casting procedure, the resin receiving layer adjoins the surface of another basic core component, the resin receiving layer is adapted to receive resin such that, after hardening the received resin, the basic core element and the another basic core element are mechanically connected with each other.

### FIELD OF INVENTION

The present invention relates to the technical field of producing rotor blades for wind turbines. In particular, the present invention relates to a basic core component for forming, together with at least one another basic core component, a core structure of a rotor blade of a wind turbine. Further, the present invention relates to a structural support assembly comprising at least one of such a basic core component and at least one further basic core component. Further, the present invention relates to a rotor blade for a wind turbine, wherein the rotor blade comprises a core structure comprising at least one of such a structural support assembly. Furthermore, the present invention relates to a method for manufacturing such a basic core component.

### ART BACKGROUND

Modern wind turbine rotor blades are normally built from fiber reinforced composites combined with lightweight materials such as balsa wood or plastic foam. The plastic foam may comprise in particular Polyvinyl chloride (PVC), Polyethylene terephthalate (PET) and/or Polybutylene terephthalate (PBT). Because of the low price, glass fiber material is preferred to carbon fiber material.

In the manufacturing process, first a gel coat is brought into the mold-forms. Afterwards, the fiber materials and lightweight materials are laid out and resin is drawn into the mold-form in particular by using a vacuum injection procedure.

The purpose of the balsa wood or plastic foam is to reduce weight in some regions of the blade which during operation are subjected only to a low mechanical stress. In these regions the rotor blades are built as a sandwich construction of the fiber reinforced composite and said balsa wood or plastic foam.

It is known to make glass fiber reinforced sandwich constructions for instance by means of a product called “NexCore”. which is commercially available from Milliken & Company, 920 Milliken Rd, M-179, Spartanburg, S.C. 29304, USA (see http://nexcore.milliken.com/product/Pages/product-overview.aspx). FIG. 13 schematically illustrates a glass fiber reinforced sandwich construction 1390, wherein the NexCore product has been used. Here similar shaped foam cores 1392 each having a trapezoidal shape are put together with one long mat of glass fiber material 1394 in order to form the reinforced sandwich construction 1390.

However this type of construction is relatively difficult to manufacture.

There may be a need for providing a basic core component for forming a core structure of a wind turbine rotor blade, wherein the basic core component is cheap and easy to produce. The resulting core structure should be light weighted and nevertheless be mechanically stable.

### SUMMARY OF THE INVENTION

This need may be met by the subject matter according to the independent claims. Advantageous embodiments of the present invention are described by the dependent claims.

According to a first aspect of the invention there is provided a basic core component for forming, together with at least one another basic core component, a core structure of a rotor blade of a wind turbine. The provided basic core component comprises (a) a precasted base element being made from a foam material, and (b) a resin receiving layer, which is adhered to at least one surface of the precasted base element. When, during a casting procedure, the resin receiving layer adjoins the surface of another basic core component, the resin receiving layer is adapted to receive resin such that, after hardening the received resin, the basic core element and the another basic core element are mechanically connected with each other.

The described basic core component is based on the idea that a core structure for a wind turbine blade can be a lattice structure comprising a plurality of the described basic core components. When this lattice structure is casted, for instance by employing a resin vacuum injection, resin will flow into and/or through the resin receiving layer being located between different basic core components. By this way, in the production of wind turbine rotor blades for instance balsa wood can be replaced with a material having an extraordinary small weight and an extraordinary large stiffness.

It is pointed out that the lateral extension of the resin receiving layer may be spatially limited to the extension of the surface of the precasted base element the resin receiving layer is adhered to. This may provide the advantage that the described basic core component can be realized as a compact component which can be easily put together with other basic core components in order to form the core structure of the core structure. When handling the basic core components there is no need to separately also handle the resin receiving layer. By contrast to a resin receiving layer, which is used as a separate mat, with the described basic core component the resin receiving layer is adhered and there is no need to take care of the handling of the resin receiving layer.

It is mentioned that the shape and/or the size of the described basic core component can be adopted to a specific shape and/or size of the wind turbine rotor blade. Further, it is possible however not essential that the basic core component and the another basic core component are of the same type (shape and/or size).

The described basic core component is advantageous in that it is easy and cheap to manufacture. When casted as a concatenated core material, the created reinforced lattice structure respectively core structure provides a strong and very well defined casted structure which, as compared to balsa wood, in a wind turbine rotor blade has at least similar or even better mechanical properties.

According to an embodiment of the invention the foam material comprises at least one of Polyurethane (PU), Polyvinyl chloride (PVC), Polyethylene terephthalate (PET) and Polybutylene terephthalate (PBT). This may provide the advantage that the precasted base element can be realized with known and comparatively cheap plastic materials.

In particular PU has the advantage that when it has been foamed, it forms a porous core with a hard and almost closed surface. This in turn has the effect that during a casting process almost no resin is infused in the porous material and consequently less resin is needed respectively used. Such a type of foam having a high-density skin and a low-density core may be for instance a so called “integral skin foam”.

According to a further embodiment of the invention the resin receiving layer comprises a glass fiber material and/or a carbon fiber material. This may provide the advantage that also the resin receiving layer can be realized with a material, which is cheap, which, together with the received resin, has a high mechanical stability and which allows for a stable mechanical connection between the basic core component and the another basic core component.

According to a further embodiment of the invention the basic core component comprises a cross sectional shape having a first side and a second side, wherein the first side is oriented inclined with respect to the second side. This may provide the advantage that different basic core components can be spatially arranged with respect to each other such that a mechanically stable lattice structure can be realized.

The described cross sectional shape may be an area having three, four, five or even more linear sides. Thereby, with respect to one side one or more of the remaining sides may be oriented inclined or oblique.

Preferably, the cross sectional shape is a triangle. In particular, the triangle may be a triangle having one right angle and/or an equal sided triangular having two or even three sides which have the same length.

According to a further embodiment of the invention the along a longitudinal extension of the basic core component the basic core component comprises a uniform cross sectional shape. This may provide the advantage that the precasted base element can be produced easily e.g. by applying an appropriate known pultrusion technique.

According to a further aspect of the invention there is described a structural support assembly for a rotor blade of a wind turbine. The described structural support assembly comprises (a) a first basic core component as set described above and (b) a second basic core component comprising at least a precasted base element being made from a foam material. Thereby, the first basic core component and the second basic core component are spatially arranged relative to each other in such a manner, that a first lateral face of the first basic core component and a second lateral face of the second basic core component are oriented parallel with respect to each other and that the resin receiving layer is located between the first lateral face and the second lateral face.

The described structural support assembly for a rotor blade of a wind turbine is based on the idea that the above described first basic core component can be used for realizing a mechanically stable and easy to produce lattice structure, which can be used as a core structure for a wind turbine rotor blade. Descriptive speaking, the described structural support assembly is build of one or more foam profiles which are lined with the resin receiving layer.

According to an embodiment of the invention the also the second basic core component is a basic core component as described above. This may mean that the two basic core components may be of the same type. This means that also the second basic core component comprises a resin receiving layer which is adhered to at least one surface of the respective precasted base element.

When assembling the two basic core components in between the first lateral face and the second lateral face there may be located (a) none resin receiving layer, (b) one resin receiving layer being associated with one of the two basic core components or (c) two resin receiving layers, wherein one resin receiving layer is associated with the first basic core component and the other resin receiving layer is associated with the second basic core component.

In the first case (a) it may be essential that in the finally produced structural support assembly there is a mechanical connection between the two basic core components. Such a mechanical connection may be established via a third basic core component and two further resin receiving layers, wherein a first further resin receiving layer is sandwiched between a side of the first basic core component and a side of the third basic core component and a second further resin receiving layer is sandwiched between a side of the second basic core component and a side of the third basic core component.

In the second case (b) there is a single resin receiving layer being sandwiched between a side of the first basic core component and a side of the second basic core component.

In the third case (c) there are two resin receiving layers being arranged on top of each other, whereby a stack of the two resin receiving layers are sandwiched between two adjacent sides of the first respectively the second basic core component.

According to a further embodiment of the invention the first basic core component is different from the second basic core component. By providing different types of basic core components a core structure can be produced for many different types of wind turbine rotor blades. Thereby, it may be advantageous if a (construction) kit comprising the different types of basic core components comprises not only one basic core components for each type of basic core components. Specifically speaking, such a (construction) kit may comprise a certain number (e.g. 2, 3, 4, . . . ) of different types of basic core components, wherein each type of basic core components is numerously available. It may also be possible that a user of the (construction) kit can reorder further basic core components, which are of a type which has run out.

According to a further embodiment of the invention the first basic core component has a first cross sectional shape and the second basic core components has a second cross sectional shape being different from the first cross sectional shape.

By using basic core components with different cross sectional shapes it may be possible to build up a core structure, which has a geometric shape being already optimized at least approximately for the final shape of the wind turbine rotor blade.

According to a further embodiment of the invention (a) the first basic core component comprises a first number of resin receiving layers each being adhered to one of the surfaces of the precasted base element of the first basic core component and (b) the second basic core component comprises a second number of resin receiving layers each being adhered to one of the surfaces of the precasted base element of the second basic core component. Thereby, the first number is different from the second number. This may provide the advantage that it can be ensured that in between each pair of adjoining surfaces of different basic core components respectively in between surfaces of different basic core components, which surfaces face each other, there will be provided not less and not more than one resin receiving layer. As a consequence, the thickness of all resin receiving layers within the whole lattice structure may be the same. By contrast to resin receiving layers having different thicknesses a uniform thickness allows to easily build up also large lattice structures comprising a large number of basic core elements.

Specifically, a basic core component being located at the edge of the core structure may be provided with a small number of resin receiving layers whereas a basic core component being located within the core structure may be provided with a larger number of resin receiving layers.

According to a further aspect of the invention there is provided a rotor blade for a wind turbine. The described rotor blade comprises a core structure comprising at least one structural support assembly as described above.

The provided wind turbine rotor blade is based on the idea that the above described structural support assembly can be used for effectively building up the core structure of the wind turbine. Thereby, the core structure, as compared to a core structure comprising balsa wood, has at least similar or even better mechanical properties.

According to a further aspect of the invention there is provided a method for manufacturing a basic core component as described above. The provided method comprises (a) precasting the precasted base element from a foam material, and (b) adhering a resin receiving layer to at least one surface of the precasted base element.

Also the described method is based on the idea that a plurality of the above described basic core components can be used to effectively and easily form a lattice framework core structure for a rotor blade of a wind turbine.

It is pointed out that the described steps of precasting and adhering may be carried out together. This can be realized by placing the resin receiving layer at lateral surfaces of a mold-form which is used for (pre)casting the precasted base element and then by inserting the foam material into the mold-form, which is lined or backed with the resin receiving layer.

The described method for manufacturing the basic core component may in particular provide the advantage that it is a simple and cheap “one-shot” process.

According to an embodiment of the invention precasting the precasted base element comprises (a) pulling the foam material and/or the resin receiving layer through a mold-form and (b) cutting the pulled foam material and/or the pulled resin receiving layer after having left the mold-form. This may provide the advantage that a basic core element having a uniform cross sectional shape can be produced easily. Thereby, a string or line material may be generated, which may theoretically have an infinite long extension. The length of the precasted base element respectively the manufactured basic core element may be adjusted by cutting the string or line material at appropriate cutting positions.

According to a further embodiment of the invention the mold-form is a closed mold-form. In this respect “closed mold-form” may mean that the mold-form comprises a hollow body which is open only at an entrance face side and at an exit face side.

It is mentioned that a lateral side of the closed mold-form may be connected to an inlet, which may allow for adding a foam raw material respectively a foam adhesive into the closed mold-form. Thereby, the foam raw material respectively the foam adhesive may be added under a pressure which is so high that it will be spatially distributed within the mold-form.

According to a further embodiment of the invention the mold-form is an open mold-form.

In this respect closed mold-form may mean that apart from an open entrance face side and an open exit face side the mold-form is also open at least at one side surface. Descriptive speaking, the open mold-form may have the shape of a trough. In case the precasted base element should have a triangular cross sectional shape, the open mold-form may have the form of a V-groove.

It is mentioned that when using an open mold-form it may occur that the precasted base element has a very uneven side corresponding to the open side surface of the open mold-form. In this case a surplus of foam material can be cut away such that after cutting the foam material again comprises only even side surfaces.

It has to be noted that embodiments of the invention have been described with reference to different subject matters. In particular, some embodiments have been described with reference to apparatus type claims whereas other embodiments have been described with reference to method type claims. However, a person skilled in the art will gather from the above and the following description that, unless other notified, in addition to any combination of features belonging to one type of subject matter also any combination between features relating to different subject matters, in particular between features of the apparatus type claims and features of the method type claims is considered as to be disclosed with this document.

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

### BRIEF DESCRIPTION OF THE DRAWING

FIG. 1 shows a basic core component having a triangular cross sectional shape.

FIG. 2 shows a structural support assembly comprising a plurality of basic core components as shown in FIG. 1 and two surface resin receiving layers.

FIG. 3 shows a perspective view of a production arrangement for producing a basic core component line material.

FIG. 4 shows a side view of the production arrangement shown in FIG. 3.

FIG. 5 shows a production arrangement for producing basic core components, wherein a cutter is provided for singularizing the basic core components from a basic core component line material.

FIG. 6 shows a production arrangement comprising an open mold-form for producing a basic core component line material.

FIG. 7 shows a structural support assembly comprising a plurality of basic core components each being of the same type.

FIG. 8 shows a structural support assembly comprising two different types of basic core components.

FIG. 9 shows a structural support assembly comprising a plurality of basic core components each having a single fiber layer being adhered to one side surface of a precasted base element of the respective basic core component.

FIG. 10 shows a structural support assembly comprising an arrangement of a plurality of basic core components each having two fiber layers being adhered to two side surfaces of a precasted base element of the respective basic core component.

FIG. 11 shows a structural support assembly comprising an arrangement of a plurality of basic core components each having only one fiber layer being adhered to one side surface of a precasted base element of the respective basic core component.

FIG. 12 shows various arrangements of differently shaped basic core components for forming a structural support assembly.

FIG. 13 schematically illustrates a glass fiber reinforced sandwich construction, wherein the known NexCore product from Milliken & Company has been used.

### DETAILED DESCRIPTION

It is noted that in different figures, similar or identical elements are provided with reference signs, which have the same last two digits.

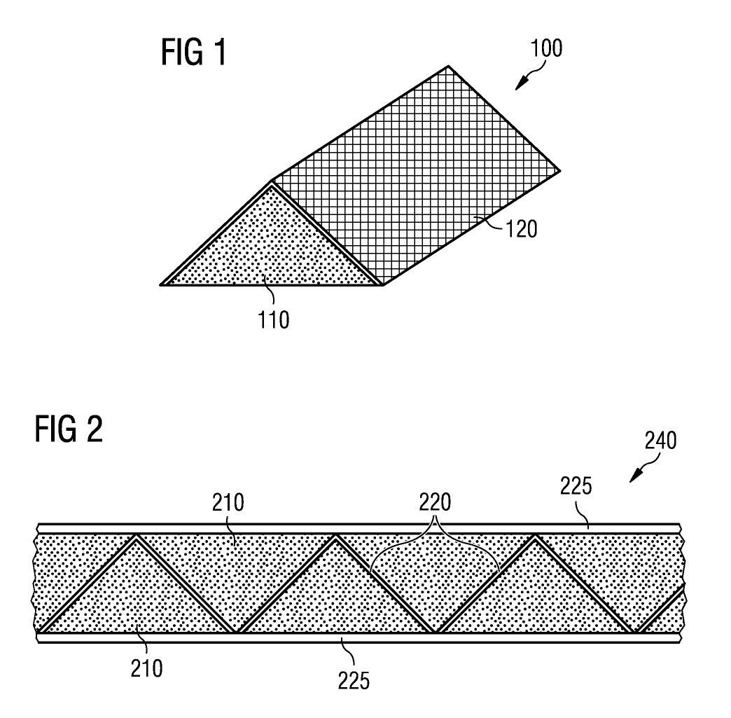

FIG. 1 shows a basic core component 100 having a triangular cross sectional shape. According to the embodiment described here the triangle has a right angle and two legs having the same length. It is mentioned that the described invention is not limited to basic core components having such a triangular cross sectional shape. Apart from triangular also other forms can be used.

The basic core component 100 comprises a precasted base element 110 being made from a foam material. Therefore, the pre-casted base element is also referred to as a foam profile 110. Attached to the two surfaces being associated with the two triangle legs having the same length is a resin receiving layer 120. According to the embodiment described here the resin receiving layer is a fiber layer 120 such as a glass fiber layer and/or a carbon fiber layer.

FIG. 2 shows a structural support assembly 240 comprising a plurality of basic core components as shown in FIG. 1. The basic core components are concatenated to form the structural support assembly 240, which represents a structural lattice framework. Each basic core component comprises a foam profile 210 and a fiber layer 220 adhered to at least one side of the foam profile 210. Further, the structural support assembly 240 comprises two layers a surface fiber material 225. Therefore, the structural support assembly 240 can be seen as sandwiched laminated lattice structure.

When the structural support assembly 240 is casted for instance by using vacuum injection, resin can flow into the fiber material 220 between the foam profiles 210 and thereby form a casted reinforced lattice-structure which can replace balsa wood in wind turbine rotor blades.

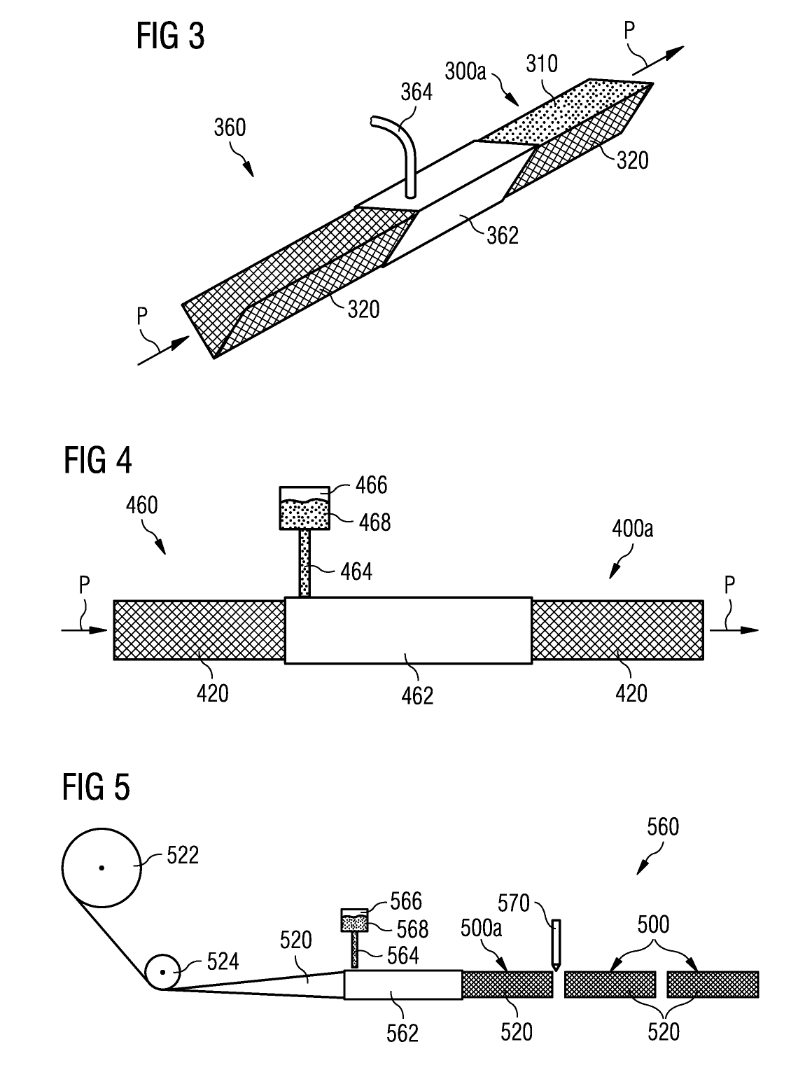

FIGS. 3 and 4 show different views of a production arrangement 360, 460 for producing a basic core component line material 300a, 400a. For producing the basic core component line material 300a, 400a the following principle is applied: A resin receiving fiber layer 320, 420 is inserted in and dragged through a mold-form 362, 462 along a pultrusion direction P. According to the embodiment described here the mold-form 362, 462 is closed and of triangular shape as illustrated in FIG. 3. The fiber layer 320, 420 is formed in order to take a desired shape such as a V-shape so that it can cover two sides of the triangular shaped foam profile 310.

While the resin receiving fiber layer 320, 420 is dragged through the mold-form 362, 462, a foam material and/or foaming adhesive 468, such as polyurethane adhesive, is injected from a reservoir 466 through a inlet 464 into the mold-form 362, 462 and to the resin receiving fiber layer 320, 420. In turn the foaming adhesive 468 hardens to generate a hard foam profile 310 which adheres to the fiber layer 320, 420.

The mold-form 362, 462 ensures that the fiber layer 320, 420 is held in place when the foam adhesive 468 is applied and when the foam hardens.

The described method may be used for producing the above described basic core component 100. Thereby, the basic core components 100 may be molded one at a time, where pre-cut lengths of fiber 320, 420 material is dragged through the mold-form 362, 462 and foaming adhesive 468 is applied.

FIG. 5 shows a production arrangement 560 for producing basic core components 500. Firstly, a continuous molded length of glass fiber material 520 being filled with a hardened foam material is produced, which represents a line or strand material respectively a basic core component line 510a.

According to the embodiment described here a roll of glass fiber material 522 is dragged through a mold-form 562. Thereby, a pulley 524 is used in order to feed the glass fiber material 522 to the mold-form 562. Within the mold-form 562 a foaming adhesive 568 is from a reservoir 566 through an inlet 564. A hardened and solid foam profile leaving the mold-form 562 is then cut in desired lengths by a cutter 570 in order to form the basic core components 500.

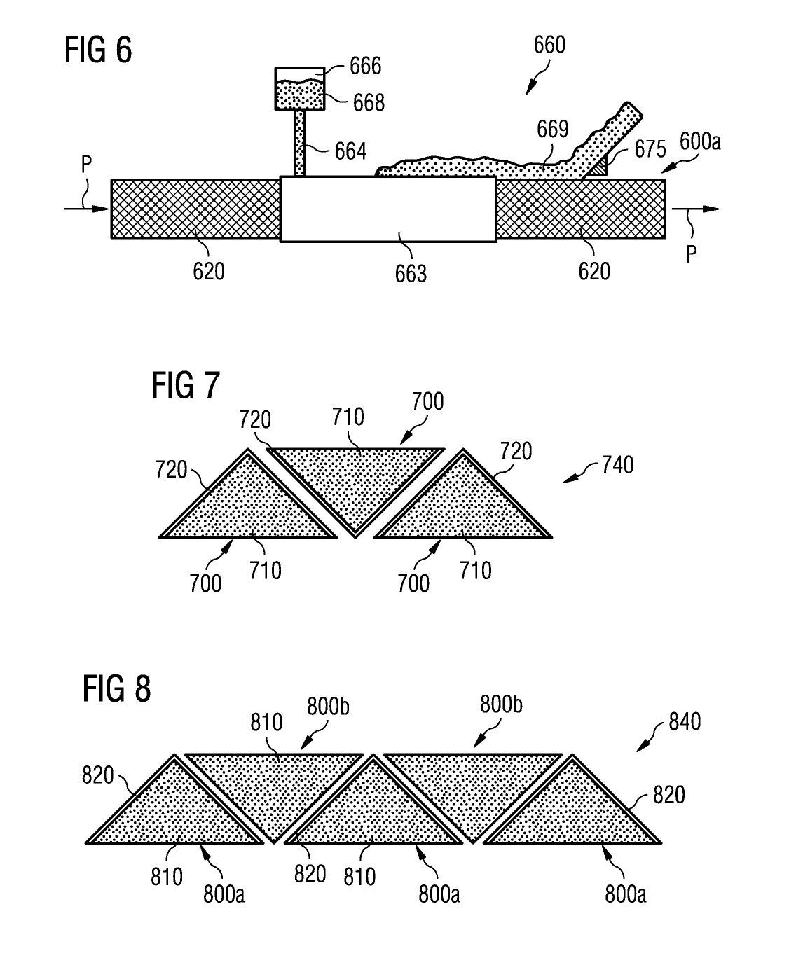

FIG. 6 shows a production arrangement 660 comprising an open mold-form 663 for producing a basic core component line material 600a. Hereby, a glass fiber layer respectively a glass fiber material 620 is dragged through the open mold-form 663 along a pultrusion direction P. A foam adhesive 668, which is inserted into the open mold-form 663 from a reservoir 666 via an inlet 664, has space to expand freely and to harden. In turn, a surplus or excessive foam material 669 is cut by a cutting means 675 and removed so as to achieve desired dimensions of the basic core component line material 600a.

FIG. 7 shows a structural support assembly 740 comprising a plurality of basic core components 700 each being of the same type. Specifically, according to the embodiment described here each basic core components 700 consists of a foam profile 710 which is covered by attached fiber material 720 such as glass fiber and/or carbon fiber.

FIG. 8 shows a structural support assembly 840 comprising two different types of basic core components 800a and 800b. One type of basic core component 800a comprises a foam profile 810 which is covered with attached fiber material 820. The fiber material 820 is attached to two side surfaces of the basic core component 800a. Another type of basic core component 800b comprises a foam profile 810 which is not covered with fiber material.

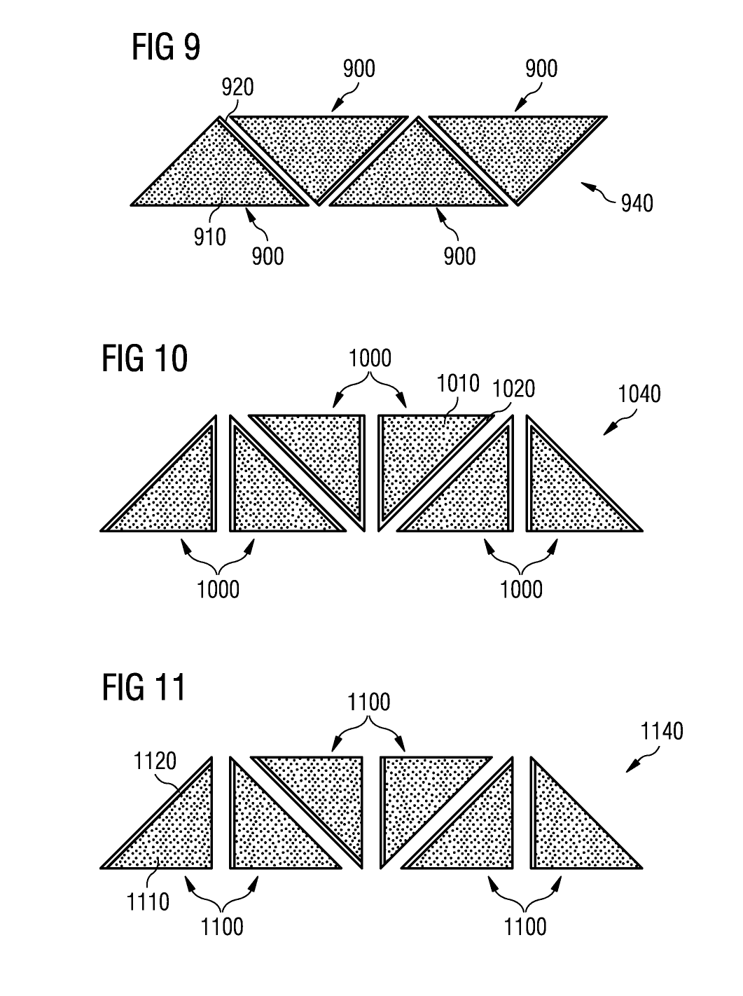

FIG. 9 shows a structural support assembly 940 comprising a plurality of basic core components 900 each having a fiber layer 920 being adhered exclusively to one side surface of a precasted base element 910 of the respective basic core component 900.

FIG. 10 shows a structural support assembly 1040 comprising an arrangement of a plurality of basic core components 1000 each having two fiber layers 1020 being adhered to two side surfaces of a precasted base element 1010 of the respective basic core component 1000.

FIG. 11 shows a structural support assembly 1140 comprising an arrangement of a plurality of basic core components 1100 each having only one fiber layer 1120 being adhered to one side surface of a precasted base element 1110 of the respective basic core component 1100.

According to further embodiments which are not illustrated in the drawing the basic core components may be covered with attacked fiber material on one or more sides and may be concatenated in various spatial patterns in order to achieve a structural support assembly which has desired mechanical properties—before and after casting.

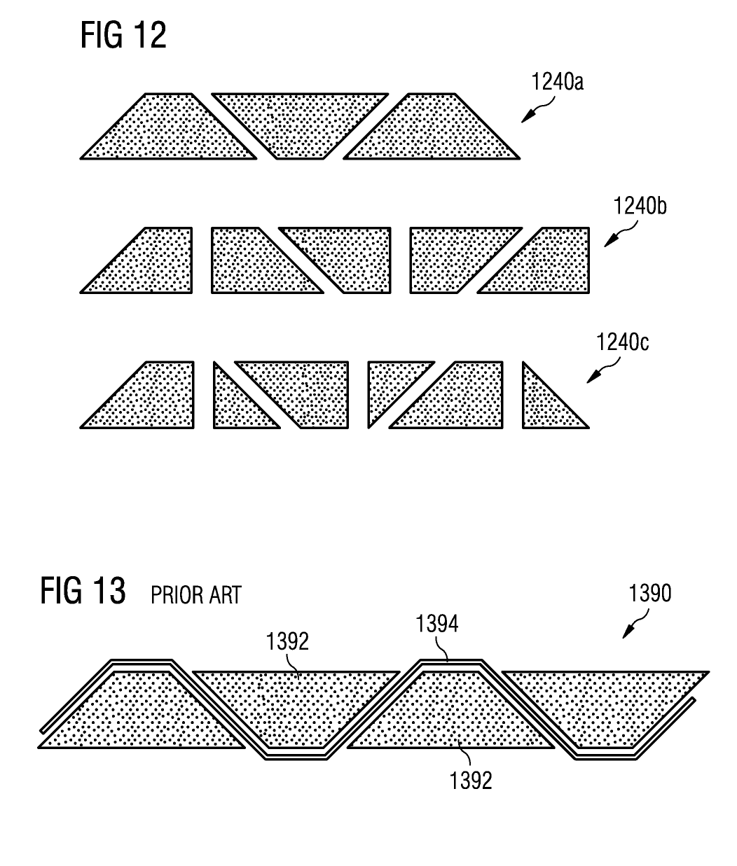

FIG. 12 shows various arrangements 1240a, 1240b and 1240c of differently shaped basic core components for forming a structural support assembly. The foamed profiles may take other cross-sectional geometric forms than triangular such as for instance trapezoidal as schematically illustrated in the arrangements 1240a and 1240b.

According to further embodiments such as the structural support assembly 1240c, different basic core components with different cross-sectional geometric forms may be concatenated.

It should be noted that the term “comprising” does not exclude other elements or steps and the use of articles “a” or “an” does not exclude a plurality. Also elements described in association with different embodiments may be combined. It should also be noted that reference signs in the claims should not be construed as limiting the scope of the claims.

### LIST OF REFERENCE SIGNS

100 basic core component

110 precasted base element/foam profile

120 resin receiving layer/fiber layer

210 precasted base element/foam profile

220 resin receiving layer/fiber layer

225 surface resin receiving layer/surface fiber layer

240 structural support assembly/structural lattice support member

300a basic core component line

310 foam profile

320 resin receiving layer/fiber layer

360 production arrangement

362 mold-form

364 inlet

P pultrusion direction

400a basic core component line

420 resin receiving layer/fiber layer

460 production arrangement

462 mold-form

464 inlet

466 reservoir

468 foam material/foaming adhesive

P pultrusion direction

500 basic core component

500a basic core component line

520 glass fiber layer

522 roll of glass fiber material

524 pulley

560 production arrangement

562 mold-form

564 inlet

566 reservoir

568 foam material/foaming adhesive

570 cutter

600a basic core component line

620 glass fiber layer/glass fiber material

660 production arrangement

663 mold-form (open)

664 inlet

666 reservoir

668 foam material/foam adhesive

669 excessive foam material

675 cutting means

P pultrusion direction

700 basic core component

710 precasted base element/foam profile

720 fiber layer/fiber material

740 structural support assembly

800a basic core component (first type)

800b basic core component (second type)

810 precasted base element/foam profile

820 fiber layer/fiber material

840 structural support assembly

900 basic core component

910 precasted base element/foam profile

920 fiber layer

940 structural support assembly

1000 basic core component

1010 precasted base element/foam profile

1020 glass fiber layer

1040 structural support assembly

1100 basic core component

1110 precasted base element/foam profile

1120 fiber layer

1140 structural support assembly

1240a structural support assembly

1240b structural support assembly

1240c structural support assembly

1390 glass fiber reinforced sandwich construction

1392 foam cores

1394 long mat of glass fiber material

1-15. (canceled)

16. A basic core component for forming, together with at least one another basic core component, a core structure of a rotor blade of a wind turbine, the basic core component comprising:
a precasted base element being made from a foam material, and
a resin receiving layer, which is adhered to at least one surface of the precasted base element,
wherein,
when, during a casting procedure, the resin receiving layer adjoins the surface of another basic core component, the resin receiving layer is adapted to receive resin such that, after hardening the received resin, the basic core element and the another basic core element are mechanically connected with each other.

17. The basic core component as set forth in claim 16, wherein the foam material comprises at least one of Polyurethane, Polyvinyl chloride, Polyethylene terephthalate and Polybutylene terephthalate.

18. The basic core component as set forth in claim 16, wherein the resin receiving layer comprises a glass fiber material and/or a carbon fiber material.

19. The basic core component as set forth in claim 16, wherein the basic core component comprises a cross sectional shape having a first side and a second side, wherein the first side is oriented inclined with respect to the second side.

20. The basic core component as set forth in claim 16, wherein along a longitudinal extension of the basic core component the basic core component comprises a uniform cross sectional shape.

21. A structural support assembly for a rotor blade of a wind turbine, the structural support assembly comprising:
a first basic core component as set forth in claim 16, and
a second basic core component comprising at least a precasted base element being made from a foam material,
wherein the first basic core component and the second basic core component are spatially arranged relative to each other in such a manner, that
a first lateral face of the first basic core component and a second lateral face of the second basic core component are oriented parallel with respect to each other, and
the resin receiving layer is located between the first lateral face and the second lateral face.

22. The structural support assembly as set forth in claim 21, wherein also the second basic core component is a basic core component as set forth in claim 16.

23. The structural support assembly as set forth in claim 21, wherein the first basic core component is different from the second basic core component.

24. The structural support assembly as set forth in claim 23, wherein the first basic core component has a first cross sectional shape and the second basic core components has a second cross sectional shape being different from the first cross sectional shape.

25. The structural support assembly as set forth in claim 23, wherein
the first basic core component comprises a first number of resin receiving layers each being adhered to one of the surfaces of the precasted base element of the first basic core component, and
the second basic core component comprises a second number of resin receiving layers each being adhered to one of the surfaces of the precasted base element of the second basic core component,
wherein the first number is different from the second number.

26. A method for manufacturing a basic core component as set forth in claim 16, the method comprising
precasting the precasted base element from a foam material, and
adhering a resin receiving layer to at least one surface of the precasted base element.

27. The method as set forth in claim 26, wherein precasting the precasted base element comprises:
pulling the foam material and/or the resin receiving layer through a mold-form, and
cutting the pulled foam material and/or the pulled resin receiving layer after having left the mold-form.

28. The method as set forth in claim 27, wherein the mold-form is a closed mold-form.

29. The method as set forth in claim 27, wherein the mold-form is an open mold-form.
